(19) United States
(12) Patent Application Publication
(10) Pub. No.: US 2020/0046105 A1
(43) Pub. Date: Feb. 13, 2020

(54) TOOL BELT WITH SPEAKERS

(71) Applicant: Travis Axtell, Port Leyden, NY (US)

(72) Inventor: Travis Axtell, Port Leyden, NY (US)

(21) Appl. No.: 16/101,454

(22) Filed: Aug. 12, 2018

(51) Int. Cl. A45F 3/00; H04R 1/02; H01M 2/10

(52) U.S. Cl. CPC A45F 3/005; B25H 3/00; H01M 2/1005; H04R 1/02

(57) ABSTRACT

A tool belt, including a main body including an adjustable belt to allow a user to wear the tool belt, at least one speaker disposed on the main body, and a battery disposed within the main body to provide power to the at least one speaker.

### BACKGROUND

### 1. Field

The present general inventive concept relates generally to a tool belt, and particularly, to a tool belt including speakers.

### 2. Description of the Related Art

When working in construction or doing home improvement projects, there are many tools required to be close in reach and readily accessible. Those who actively engage in construction or hardware activities need a tool belt that offers high comfort and durability for long durations when worn. Current tool holding accessories are limited with regard to innovative functions, and typically only facilitate tool access and organization.

Therefore, there is a need for a tool holding accessory that offers novelty and entertainment for a user.

### SUMMARY

The present general inventive concept provides a tool belt including speakers.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a tool belt, including a main body including an adjustable belt to allow a user to wear the tool belt, at least one speaker disposed on the main body, and a battery disposed within the main body to provide power to the at least one speaker.

The main body may include at least one pocket disposed on the main body.

The at least one speaker may play music stored on a mobile device.

The at least one speaker may communicate wirelessly with the mobile device.

The main body may include a battery pack holder disposed on the main body to allow the battery to provide power to the at least one speaker when the battery is inserted therein.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1 illustrates a tool belt, according to an exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the FIGURE, the thicknesses of lines, layers and/or regions may be exaggerated for clarity.

Accordingly, while example embodiments are capable of various modifications and alternative forms, embodiments thereof are shown by way of example in the FIGURE and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

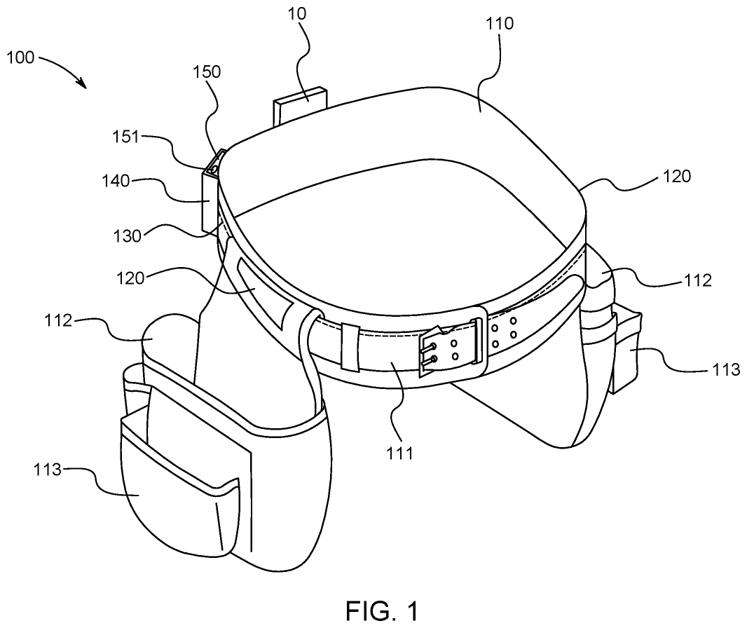

FIG. 1 illustrates a tool belt 100, according to an exemplary embodiment of the present general inventive concept.

The tool belt 100 may include a main body 110, at least one speaker 120, an auxiliary cable 130, a battery pack holder 140, and a battery 150.

The main body 110 may be shaped like a tool belt known to one of ordinary skill in the art, and may hold a variety of different types of tools.

The main body 110 may include a belt 111 that may be adjustable to allow a user to wear the tool belt 100. The main body 110 may also include at least one main pocket 112 disposed at a side portion of the main body (and optionally attached to the belt 111), and at least one auxiliary pocket 113 disposed on the at least one main pocket 112. The at least one main pocket 112 and the at least one auxiliary pocket 113 may be standard pockets, or may include openings at bottom portions thereof to allow tools to be “threaded” therethrough.

The at least one speaker 120 may be disposed at the main body 110, the at least one main pocket 112, or anywhere else on the tool belt 100.

The at least one speaker 120 may have wireless communication capabilities, such as WIFI, BLUETOOTH, etc., and may be connectable to an Intranet or the Internet. As such, the at least one speaker 120 may communicate with a mobile device 10, such that the at least one speaker 120 may play music stored within the mobile device 10.

The at least one speaker 120 may be provided in plurality, in order to allow the user to hear music output therefrom to be in stereo.

The mobile device 10 may be attached to the tool belt 100 via a pocket or compartment (or alternatively may be place within the at least one main pocket 112 or the at least one auxiliary pocket 113), and may be embodied as a cellular telephone, music player, or any other device that may play, record, and/or output music.

The auxiliary cable 130 may be connected to the at least one speaker 120, to allow the mobile device 10 to be connected via a wired connection to the at least one speaker 120.

The battery pack holder 140 may be disposed on the main body 110, and may include a connecting portion to allow the battery 150 to provide power directly to the at least one speaker 120 via wires and cables provided within the main body 110. In other words, the battery pack holder 140 may be disposed on the main body 110 to allow the battery 150 to provide power to the at least one speaker 120 when the battery 150 is inserted therein. Alternatively, the battery 150 may have wireless communication properties to provide wireless power to the at least one speaker 120.

The battery 150 may also include a power button 151, in order to allow the at least one speaker 120 to be turned on and/or off when the user depresses the power button 151, based on the user's preference.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A tool belt, comprising:
a main body including an adjustable belt to allow a user to wear the tool belt, the main body comprising:
at least one pocket disposed on the adjustable belt, such that the at least one pocket is suspended below the main body;
at least one speaker disposed on an outer surface of the at least one pocket, such that the at least one pocket is empty; and
a battery disposed within the main body to provide power to the at least one speaker.

2. (canceled)

3. The tool belt of claim 1, wherein the at least one speaker plays music stored on a mobile device.

4. The tool belt of claim 3, wherein the at least one speaker communicates wirelessly with the mobile device.

5. The tool belt of claim 1, wherein the main body comprises:
a battery pack holder disposed on the main body to allow the battery to provide power to the at least one speaker when the battery is inserted therein.

6. A tool belt, comprising:
a main body;
an adjustable belt disposed on an outer surface of the main body to allow a user to wear the main body;
at least one main pocket disposed on the main body, such that the at least one main pocket is suspended below the main body;
at least one auxiliary pocket disposed on at least a portion of the at least one main pocket; and
at least one speaker disposed on an inner surface of the at least one auxiliary pocket.
